(19) United States
(12) Patent Application Publication
(10) Pub. No.: US 2008/0130868 A1
(43) Pub. Date: Jun. 5, 2008

(54) Scrambler and storage device using the same

(75) Inventor: Hiroaki Ueno, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/897,476

(22) Filed: Aug. 30, 2007

(30) Foreign Application Priority Data
Nov. 30, 2006 (JP) 2006-322893

(51) Int. Cl. H04K 1/00

(52) U.S. Cl. 380/22

(57) ABSTRACT

A scrambler that facilitates encryption of data to be recorded and a magnetic storage device using this are provided. The scrambler has a shift register of a plurality of stages and an exclusive OR circuit that finds the exclusive OR of the logic of the stages of the shift register that correspond to a single generating polynomial. The output of the exclusive OR circuit is arranged to be fed back to the initial stage of the shift register. At least this single generating polynomial is an arbitrary generating polynomial. The drive number, in binary form, that identifies the storage device, is set as the initial value of the shift register of a plurality of stages.

### CROSS-REFERENCE TO RELATED APPLICATIONS

This application is based upon and claims the benefit of priority from the prior Japanese Patent Application No. 2006-322893, filed on Nov. 30, 2006, the entire contents of which are incorporated herein by reference.

### BACKGROUND OF THE INVENTION

1. Field of the Invention

The present invention relates to a scrambler that scrambles input data and to a storage device using this.

2. Description of the Related Art

Scramblers are employed in order to randomize data. A scrambler may have a construction whereby the exclusive OR of the logic states of a plurality of prescribed stages corresponding to a generating polynomial is found, and these are fed back to the initial stage of a shift register.

A construction may be adopted in which the generating polynomial that is used and the initial values that are initially set in the shift register are fixed, or in which these are selectively set from prescribed values.

As an example of prior art relating to scramblers, according to the invention disclosed in Laid-open Japanese Patent Application No. 2003-16738, a scrambling operation is performed such that recorded signals of the same form or arrangement do not appear in adjacent tracks when information is recorded on an optical disk such as a DVD. Thus a scrambling signal sequence is generated in which the scrambler generating polynomial is sequentially changed over on completing a single track circuit of the disk.

The invention of Laid-open Japanese Patent Application No. 2003-8449 relates to an encoding calculation circuit that makes possible changeover at will of the generating polynomial, in an encoding system for detection/correction of errors on reception of a data signal.

Laid-open Japanese Patent Application No. H. 10-23389 relates to an image scrambler and is characterized in that there is incorporated in an integrated circuit a circuit that can be used to set a generating polynomial at will in order to avoid the existence of a risk of unauthorized decoding resulting from external provision of a random number circuit when arranging to differentiate levels of concealment of image information for each receiving station.

Regarding the various items of prior art, in Laid-open Japanese Patent Application No. 2003-16738 and Laid-open Japanese Patent Application No. 2003-8449, a construction is adopted in which the generating polynomial and the set initial values are fixed or selected from prescribed values. Also, in Laid-open Japanese Patent Application No. H. 10-23389, there is a suggestion that the generating polynomial that is employed in the scrambler could be set to an arbitrary value, but the initial value of the scrambler is not mentioned.

Consequently, in the inventions set out in Japanese Patent Application No. 2003-16738, Laid-open Japanese Patent Application No. 2003-8449 and Laid-open Japanese Patent Application No. H. 10-23389, the number of combinations and the level of redundancy achieved by the range of selection of the generating polynomial and the set initial values are low, so these cannot be used to achieve encryption and the information of the medium can easily be read out.

### SUMMARY OF THE INVENTION

An object of the present application is therefore to provide a scrambler and storage device using this whereby encryption of data to be recorded can easily be achieved.

In order to solve the above problem, a scrambler according to first aspect of the present invention has a plurality of shift register stages and an exclusive OR circuit for finding the exclusive OR of the logic of the shift register stages corresponding to a single generating polynomial, output of the exclusive OR circuit being fed back to the initial stage of the shift register, and at least one of the generating polynomial or the initial value set in the shift register being arbitrarily set.

In order to solve the above problem, a scrambler for encrypting data in a storage device according to a second aspect of the present invention has a plurality of shift register stages and an exclusive OR circuit for finding the exclusive OR of the logic of the shift register stages corresponding to a single generating polynomial, output of the exclusive OR circuit being fed back to the initial stage of the shift register, and at least one aforesaid generating polynomial being an arbitrary generating polynomial, and a drive number in binary form that identifies the storage device being set as the initial value of the plurality of shift register stages.

In order to solve the above problem, a scrambler for encrypting data in a magnetic storage device according to a third aspect of the present invention has a plurality of shift register stages and an exclusive OR circuit for finding the exclusive OR of the logic of the shift register stages corresponding to a single generating polynomial, output of the exclusive OR circuit being fed back to the initial stage of the shift register, and at least one aforesaid generating polynomial being an arbitrary generating polynomial, and at least one of the cylinder number (storage medium number), head number and sector number of the magnetic storage device in binary form being set as the initial value of the plurality of shift register stages.

In order to solve the above problem, a scrambler for encrypting data in a magnetic storage device according to a fourth aspect of the present invention has a plurality of shift register stages and an exclusive OR circuit for finding the exclusive OR of the logic of the shift register stages corresponding to a single generating polynomial, output of the exclusive OR circuit being fed back to the initial stage of the shift register, and at least one aforesaid generating polynomial being an arbitrary generating polynomial, and the exclusive OR of an arbitrary combination of the cylinder number, head number or sector number of the magnetic storage device in binary form being set as the initial value of the plurality of shift register stages.

In order to solve the above problem, a magnetic storage device according to a fifth aspect of the present invention for encrypting and recording input data has a circuit that generates encrypted data using the exclusive OR of input data that is to be magnetically recorded and a scrambling signal scrambled by a scrambler, and a control section that performs control and the encrypted data from the circuit that generates the encrypted data is recorded on a magnetic disk; wherein the scrambler has a plurality of shift register stages and an exclusive OR circuit that finds the exclusive OR of the logic of the shift register stages corresponding to a single generating polynomial, and is configured such that the output of the exclusive OR circuit is fed back to the initial stage of the shift register, and at least one aforesaid generating polynomial is an arbitrary generating polynomial and at least one of the cylinder number, head number and sector number of the magnetic storage device in binary form is set as the initial value of the plurality of shift register stages.

Furthermore, a magnetic storage device according to a sixth aspect of the present invention that encrypts and records input data has a circuit that generates encrypted data using the exclusive OR of input data that is to be magnetically recorded and a scrambling signal scrambled by a scrambler, and a control section that performs control and the encrypted data from the circuit that generates the encrypted data is recorded on a magnetic disk; wherein the scrambler has a plurality of shift register stages and an exclusive OR circuit for finding the exclusive OR of the logic of the shift register stages corresponding to a single generating polynomial, and is configured such that the output of the exclusive OR circuit is fed back to the initial stage of the shift register, and at least one aforesaid generating polynomial is an arbitrary generating polynomial and the exclusive OR of an arbitrary combination of the cylinder number, head number or sector number of the magnetic storage device in binary form is set as the initial value of the plurality of shift register stages.

A high degree of security can easily be guaranteed for the recorded user data by the above characteristics.

### BRIEF DESCRIPTION OF THE DRAWINGS

FIG. 1 is a view given in explanation of an embodiment of a scrambler according to the present invention; and

FIG. 2 is a view given in explanation of a magnetic recording device to which a scrambler according to the present invention has been applied.

### DESCRIPTION OF THE PREFERRED EMBODIMENTS

An embodiment of the present invention is described below with reference to the drawings. It should be noted that this embodiment is merely given to facilitate understanding of the present invention and application of the present invention is not to be restricted to the scope thereof.

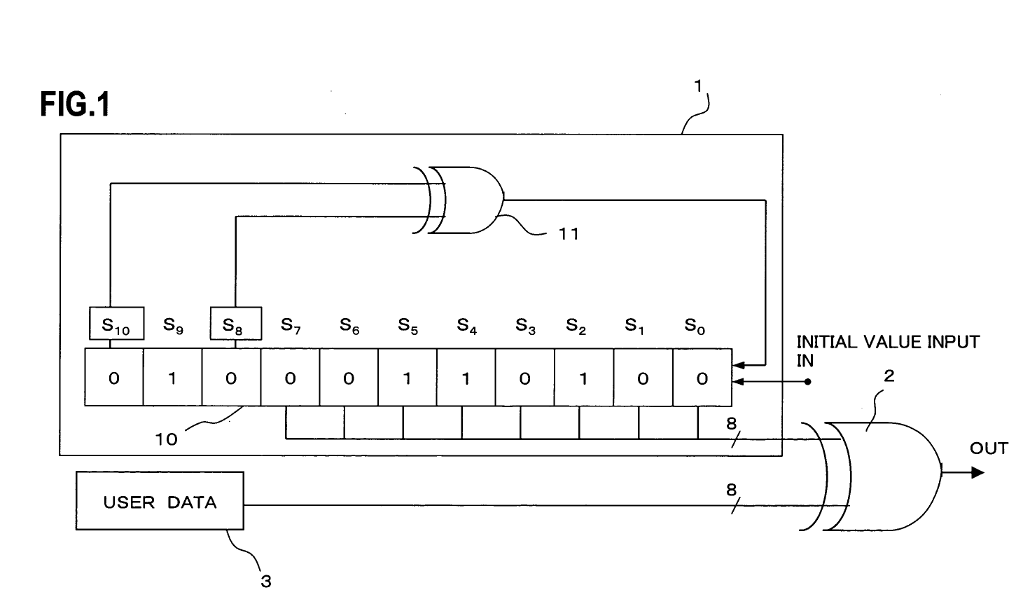

FIG. 1 is a view given in explanation of an embodiment of a scrambler according to the present invention.

In FIG. 1, a scrambler 1 comprises a shift register 10 of a plurality of stages (11 stages in the case of the example of FIG. 1) and an exclusive OR circuit 11 that finds the exclusive OR of the logic of prescribed stages of the shift register 10 corresponding to an arbitrary generating polynomial.

The output of the exclusive OR circuit 11 is connected so as to be fed back to the initial stage (S0) of the shift register 10.

In the example shown in FIG. 1, an arbitrary generating polynomial of one type is the three-term M sequence (X¹⁰+X⁸+1). Connection is therefore effected to the exclusive OR circuit 11 such that the exclusive OR of the logic of S10 and S8 is obtained.

An arbitrary initial value is set in the shift register 10.

In addition, in FIG. 1, the 8 bits of the least significant eight stages of the shift register 10 are input to an exclusive OR circuit 2 as a parallel signal. Also, the user data 3 that is to be randomized is input to the exclusive OR circuit 2 as an 8-bit parallel signal.

Consequently, the user data 3 can be randomized by adding the user data 3 and the output of the scrambler 1 by using the exclusive OR circuit 2 i.e. by performing exclusive OR calculation. Preferably, in application of the present invention, an M sequence (maximum length sequence) polynomial is employed as the arbitrary generating polynomial referred to above, although there is no restriction to this. In an M sequence, runs of logic 0 and 1 appear to an equal degree, so the maximum degree of irregularity can be achieved.

In this way, the randomization of the user data 3 can be further increased by employing an M sequence polynomial.

Although there are no restrictions regarding the application in which the scrambler according to the present invention for performing randomization of user data 3 may be employed, as one example, high security in respect of recorded data can be guaranteed by randomization of the user data 3 recorded on a storage device.

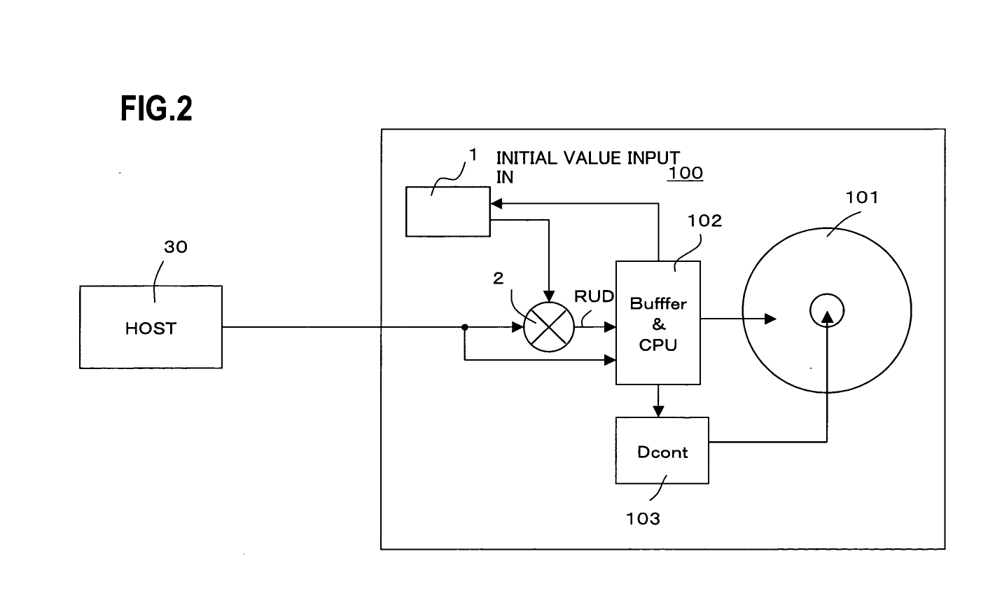

FIG. 2 shows an example in which a scrambler according to the present invention is applied to a magnetic storage device, as a storage device.

As a practical example, the scrambler 1 described in FIG. 1 according to the present invention may be incorporated in the magnetic recording device 100.

In FIG. 2, the magnetic recording device 100 is connected with a computer 30 constituting an upper layer host device, as a peripheral.

The magnetic recording device 100 magnetically records user data from the upper layer host device 30 on a plurality of magnetic disks 101, such as hard disks.

Control such as control of rotation, head movement and positional location of the magnetic disk 101 are performed by the disk control section 103. The data of the information for this control, comprising the hard disk geometry, is generated by a main control section 102 using for example the write address of the recorded data, and is sent to the disk control section 103 every time recording control is executed.

The main control section 102 comprises a data buffer function and a CPU for overall control.

The concept of hard disk geometry includes for example the drive number that specifies the magnetic storage device itself or head number corresponding to the above control information, cylinder number and sector number.

The head number is a number that specifies the respective head of a plurality of heads for performing writing/reading, that are respectively associated with a plurality of magnetic disks 101.

The cylinder number is a number for classifying tracks on a disk in accordance with the position thereof.

In addition, the sector number is a number for specifying the units into which each track on a disk is divided.

In application of the present invention, the binary value of an arbitrary number of any of for example the drive number specifying the magnetic storage device itself, or head number, cylinder number or sector number corresponding to the control information constituting the hard disk geometry is supplied to the shift register 10 of the scrambler 1 as an initial setting value from the main control section 102 and is set in the shift register 10.

It should be noted that the head number, cylinder number and sector number are generated by the main control section 102 corresponding to the address on the disk at which user data that is sent from the computer 30, constituting the upper layer device, as will be described, is recorded.

The scrambling signal is generated by, in the process and this value that is initially set in the shift register 10 is set and successively shifted, calculating the exclusive OR of the logic state of the shift stage corresponding to the arbitrary generating polynomial by using the exclusive OR circuit 11, this then being returned to the initial stage and circulated. The scrambling signal from the scrambler 1 is then input to the exclusive OR circuit 2.

Turning to the user data that is to be recorded on the magnetic disk 101, this user data is then sent from the computer 30 that is in the upper layer position and is input to the exclusive OR circuit 2. At the same time, this data is input directly to the main control section 102. As previously described, the purpose of this is to generate the geometry of the hard disk in the main control section 102, based on the recording address of the user data.

The exclusive OR circuit 2 then generates randomized user RUD by combining (calculating the exclusive OR of) the user data from the upper-layer device 30 with the scrambling signal from the scrambler 1.

The randomized user data RUD is then temporarily written to the buffer of the main control section 102. The randomized user data RUD read from the buffer of the main control section 102 is then written in the address position under the control of the write head by the disk control section 103.

This user data RUD that is thus randomized cannot be deciphered without performing descrambling processing corresponding to the scrambling signal. Consequently, high security can be guaranteed in respect of the user data by application of the present invention.

From the point of view of miniaturization of the equipment on which it is installed, the scrambler in accordance with the present invention is preferably formed by a semiconductor integrated circuit. Furthermore, application of a scrambler in accordance with the present invention to a magnetic recording device constituted by an HDD (hard disk drive) device as shown in FIG. 2 may be envisioned. In such an HDD device, for example an RDC (read channel IC), HDC (hard disk controller) and interface circuit may be employed in integrated circuit form, respectively individually or integrated with each other.

Preferably therefore, as a practical example, a scrambler in accordance with the present invention may be formed as an integrated circuit for reproduction of a magnetic recording, that is integrated with for example an RDC (read channel IC), HDC (hard disk controller) or CPU.

In addition, as described above, descrambling processing corresponding to the scrambling conditions set in accordance with the present invention is necessary in order to read the recorded signal processed by the scrambler in accordance with the present invention from the recording medium and recover decipherable data. Circuitry for such processing may be realized by utilizing the construction of the scrambler or by forming a descrambler construction in the same integrated circuit in parallel therewith.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A scrambler comprising:
a shift register of a plurality of stages; and
an exclusive OR circuit for finding the exclusive OR of the logic of stages of said shift register corresponding to a single generating polynomial,
output of said exclusive OR circuit being fed back to the initial stage of said shift register, and at least one of said generating polynomial and the initial value set in said shift register being arbitrarily set.

2. The scrambler according to claim 1, wherein an arbitrary initial value is set in said shift register.

3. The scrambler according to claim 1, wherein said one generating polynomial is an M sequence generating polynomial.

4. The scrambler according to claim 2, wherein said one generating polynomial is an M sequence generating polynomial.

5. A scrambler for encryption of data on a storage device, comprising:
a shift register of a plurality of stages; and
an exclusive OR circuit for finding the exclusive OR of the logic of stages of said shift register corresponding to a single generating polynomial,
output of said exclusive OR circuit being fed back to the initial stage of said shift register, and at least said generating polynomial being an arbitrary generating polynomial,
as the initial value of said shift register of a plurality of stages, the binary number of at least one of the drive number identifying said storage device, the cylinder number, head number and sector number of said storage device, or the binary number of the exclusive OR of an arbitrary combination thereof being set.

6. The scrambler according to claim 5, wherein said one generating polynomial is an M sequence generating polynomial.

7. A storage device for encrypting and recording input data, comprising:
a circuit that generates encrypted data by the exclusive OR of input data to be magnetically recorded and a scrambling signal scrambled by a scrambler; and
a control section that exercises control of recording of encrypted data from the circuit that generates said encrypted data onto a magnetic disk, wherein
said scrambler comprises:
a shift register of a plurality of stages; and
an exclusive OR circuit that finds the exclusive OR of the logic of stages of said shift register corresponding to one generating polynomial, and wherein
said scrambler is configured so that the output of said exclusive OR circuit is fed back to the initial stage of said shift register, and at least said one generating polynomial is an arbitrary polynomial, and wherein
as the initial value of said shift register of a plurality of stages, there is set the binary number of at least one of the cylinder number, head number and sector number of said storage device, or the binary number of the exclusive OR of an arbitrary combination thereof.

8. The magnetic storage device according to claim 7, wherein said one generating polynomial is an M sequence generating polynomial.

9. A semiconductor integrated circuit comprising:
a shift register of a plurality of stages; and
an exclusive OR circuit for finding the exclusive OR of the logic of stages of said shift register corresponding to one generating polynomial,
further comprising a scrambler so that output of said exclusive OR circuit is fed back to the initial stage of said shift register, and at least one of said generating polynomial and the initial value set in said shift register is arbitrarily set.

10. The semiconductor integrated circuit according to claim 9, further comprising a recording circuit for signal processing to record a signal on a recording medium.
